(19) United States
(12) Patent Application Publication
(10) Pub. No.: US 2007/0011288 A1
(43) Pub. Date: Jan. 11, 2007

(54) Apparatus and method for achieving thermal management through the allocation of redundant data processing devices

(75) Inventors: Moises Cases, Austin, TX (US); Daniel N. de Araujo, Cedar Park, TX (US); Menas Roumbakis, Venetia, PA (US); Nam Huu Pham, Round Rock, TX (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 11/141,400

(22) Filed: May 31, 2005

(51) Int. Cl. G06F 15/173

(52) U.S. Cl. 709/223

(57) ABSTRACT

Data processing devices arranged in a redundant manner, with each of the devices including a thermal sensor measuring its operating temperature, are allocated so that data is processed by the coolest available device. In one form of the invention, the same data is stored in two data storage devices to be retrieved from the device having a cooler operating temperature. When the data is to be stored, it may further be stored in the coolest one of a number of storage devices. In other forms of the invention, the data processing devices are, for example, adapter circuits or computer systems accessed by a server.

### BACKGROUND OF THE INVENTION

1. Field of the Invention

This invention relates to the cooling of data processing devices, and, more particularly, to the operation of redundant data processing devices in a manner optimizing the cooling of these devices.

2. Summary of the Background Art

For a number of computer components, increases in processing speeds and in component capabilities are increasing the rates at which heat is generated within the components, while advances in component design and in manufacturing processes are decreasing the size of the components. Both of these trends make it increasingly difficult to adequately remove heat from the components as they are operated. For example, increases in the operating speed of microprocessors are pushing the requirements on the speeds at which data is written to and read from computer memory to new levels, while a long-capacity that can occupy a particular space within a computer system.

Conventional methods for increasing the effectiveness with which computer components are cooled include the use of larger cooling devices, such as fans and heatsinks and the utilization of new technologies for cooling, such as heat pipes. Problems with such methods include the additional cost and system space required for their implementation, an increased noise level associated with the use of larger fans or additional fans, and a decrease in reliability resulting from a need to rely on increasingly complex structures of cooling devices.

Due to increasing levels of reliance on data generated and stored within computer systems, a number of methods have been adapted to prevent data loss through redundancy. A common method for providing redundancy relies on mirroring, with the same data being stored in two locations, so that information can be read from one of these locations even if the data in the other location is lost. Multiple locations for data storage may include separate hard disk units, separate locations in system memory, or even separate storage devices connected by a network. Redundancy is also used to provide increased levels of performance through an ability to use multiple instances of redundant resources, such as processors, as well as data storage. What is needed is a method for using redundant resources so that the cooling of components is optimized, preferably without a need to rely on the use of larger or additional conventional cooling devices.

U.S. Pat. No. 5,732,215 describes an array of direct access storage devices (DASDs), such as disk drive devices that includes a temperature sensor for sensing the operating temperature of each DASD. The operating temperatures of the DASDs of the array are equalized by allocating frequently accessed data to drives with relatively low operating temperatures and allocating infrequently accessed data to drives with relatively high operating temperatures. Operating temperature information is used to identify a DASD that has a high probability of failure, so that the DASD can be shut down for replacement prior to actual failure by moving all data from the DASD to one or more other DASDs of the array. What is needed is a method for determining how to store data for optimized cooling without a need to predetermine how frequently the data will be accessed, since such information may be unavailable when the data is stored. Additionally, since many forms of data are read many times as often as they are written, and since such data is often redundantly recorded in different locations, what is needed is a way to control the reading of redundantly recorded data in a manner optimizing the cooling of DASD units.

U.S. Pat. Nos. 5,900,007 and 5,787,462 each describe a system including a large array of small disk files, in which individual disk files are assigned to be used in a manner minimizing the overheating of the disk files during normal operation of the system. In accordance with U.S. Pat. No. 5,900,007, before the disk array is used, it is configured into subsets, called clusters, by the configuration management system in a mapping process calculated to disperse the disk files in each cluster so that all files in the cluster can be active simultaneously without creating a localized thermal overload situation, or “hot spot,” within the disk array. Then, during operation, the power manager also maintains the disk array in conformance with thermal and power constraints to avoid excessive power consumption or thermal overload while keeping active the optimal subset of the disk array based on the storage requests pending at any point in time. In accordance with U.S. Pat. No. 5,787,462, a configuration management subsystem assigns heat producing devices, such as the disk files, to dusters so that the number of devices activated will not create overheating, regardless of which limited set of clusters is activated. The subsystem receives the dimensions of a critical box that defines an arrangement of the devices into cells so that. if a device is assigned to each cell of the critical box and all devices are operated simultaneously. then thermal operating restrictions of the devices will be exceeded.

U.S. Pat. No. 6,470,238 describes a method for controlling device temperature. The method involves determining access rate to a component, comparing the access rate with a predetermined threshold modified by a weighted value and controlling the temperature of the component through corrective action.

U.S. Pat. App. Pub. No. 2003/0125900 A1 describes a system that includes a microprocessor and a thermal control subsystem. The microprocessor includes execution resources to support processing of instructions and consumes power. The microprocessor also includes at least one throttling mechanism to reduce the amount of heat generated by the microprocessor. The thermal control subsystem is configured to estimate an amount of power used by the microprocessor and to control the throttling mechanism based on the estimated amount of current power usage to ensure that junction temperature will not exceed the maximum allowed temperature.

### SUMMARY OF THE INVENTION

In accordance with a first aspect of the invention, data processing apparatus is provided, including a data source, a number of data processing devices, a number of thermal sensors, and a control device. The data source provides data for processing within the data processing apparatus. The data processing devices are connected to the data source to receive data for processing. Each of the thermal sensors measures and operating temperature of a device in the number of data processing devices and produces a temperature signal indicating the operating temperature measured. The control device operates in response to the temperature signal from each of the thermal sensors to select a data processing device within the number of data processing devices having a temperature cooler than at least one other data processing device within the plurality of data processing devices and to cause data to be processed within a selected data processing device.

Preferably, the control device includes a microprocessor programmed to execute instructions of a temperature tracking routine generating a temperature tracking data structure including data indicating an operating temperature measurement within each of the data processing devices, and to execute instructions of a device allocation routine determining which data processing device processes data from the data source. The data processing apparatus then additionally includes storage holding the temperature tracking data structure.

The data processing devices are understood to include devices, such as computer systems, that perform various functions, including comparisons and arithmetic manipulations on data, devices, such as adapter circuits, that manipulate data signals so that the data can be moved from one hardware interface to another, and data storage devices, such as hard disk drive devices, that store data for later retrieval. In each case, the data processing devices are understood to be redundant, in that two or more devices are available to perform the desired function. While the control device is provided to choose among the redundant devices on the basis of measured operating temperatures, the control device may also determine if the redundant devices are available and suitable for the intended purpose.

In accordance with another aspect of the invention, a method for allocating redundant data processing devices is provided, with the method including generating a temperature tracking data structure and allocating one of the data processing devices. The temperature tracking data structure includes a data record indicating an operating temperature of each of the devices. The device allocated for processing data has an operating temperature within the temperature tracking data structure to be lower than at least one other of the data processing devices. The allocation of a data processing device within a number of data processing devices is understood to mean the enablement of the particular device to perform the data processing function. Such enablement may be provided by conditioning the device to perform the processing function or by directing a data signal to the particular device.

In accordance with yet another aspect of the invention, a method for storing and retrieving data within redundant data storage devices. In this context, data storage devices are considered to be a form of data processing devices. The method includes writing data to be stored in two data storage devices within the redundant data storage devices, determining which of two redundant data storage devices in which data is to be retrieved is cooler, and reading the data to be retrieved from the cooler of the two redundant data storage devices. This method may also include determining which data storage devices are the two coolest data storage devices from data stored within the temperature tracking data structure and writing data to these two coolest data storage devices.

Alternately, the redundant data storage devices may be arranged in pairs, with the temperature tracking data record including a data record associated with each of the pair of data storage devices. The data records may then be stored in order of the measured operating temperature of the hotter device within each pair, so that data is written to the pair of data storage devices having in which the hotter storage device is the coolest for all of the pairs of data storage devices.

### BRIEF DESCRIPTION OF THE DRAWINGS

FIG. 1 is a block diagram of apparatus built in accordance with the present invention;

FIG. 2 is a block diagram of data storage apparatus built in accordance with a first embodiment of the invention;

FIG. 3 is a block diagram of a computer system configured to operate data storage in accordance with the first embodiment of the invention;

FIG. 4 is a block diagram of information stored in nonvolatile storage within the computer system of FIG. 3;

FIG. 5 is a pictographic view of a data record within a first version of a temperature data structure within the nonvolatile storage of FIG. 4;

FIG. 6 is a pictographic view of a data record within a first version of an allocation data structure within the nonvolatile storage of FIG. 4;

FIG. 7 is a flow chart of processes occurring during the execution of a temperature tracking routine within the computer system of FIG. 3;

FIG. 8 is a flow chart of processes occurring as device data is written to a temperature data structure during the processes of FIG. 7;

FIG. 9 is a flow chart of processes occurring during the execution of a first version of a storage allocation routine within the computer system of FIG. 3;

FIG. 10 is a pictographic view of a data record within a second version of a temperature data structure within the nonvolatile storage of FIG. 4;

FIG. 11 is a pictographic view of a data record within a second version of an allocation data structure within the nonvolatile storage of FIG. 4;

FIG. 12 is a flow chart of processes occurring during the execution of a second version of a storage allocation routine within the computer system of FIG. 3;

FIG. 13 is a flow chart of processes occurring during the execution of a third version of a storage allocation routine within the computer system of FIG. 3;

FIG. 14 is a block diagram of a system including a remote network server built to operate in accordance with a second embodiment of the invention;

FIG. 15 is a block diagram of a system including a server built to operate in accordance with a third embodiment of the invention; and

FIG. 16 is a fragmentary cross-sectional elevation of a computer system in the system of FIG. 15.

### DETAILED DESCRIPTION OF THE INVENTION

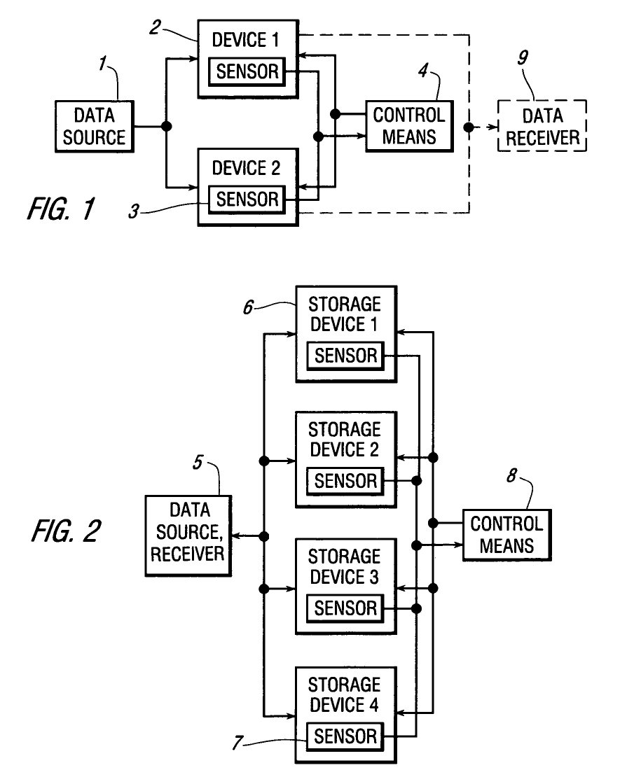

FIG. 1 is a block diagram of apparatus built in accordance with the present invention to include a data source 1 and a number of data processing devices 2, each of which is equipped with a thermal sensor 3 providing a signal indicating the operating temperature of the associated device 2. The devices 2 form an array of at least two devices that are redundant in the sense that data from the data source 1 may be transferred into each of the devices 2 for processing. Each of the thermal sensors 3 is connected to provide a signal to control means 4, which controls the flow of data through the data processing devices 2 by enabling one of the devices 2 to process data available to all of the devices 2 or, alternatively, by controlling the flow of data so that only one of the devices 2 receives the data. The operating temperatures of the devices, determined from the signals provided by the thermal sensors 3, are factors in the determination of the device that is enabled to receive data, with data preferably being sent to the coolest device 2. Other factors may be considered as well, such as the availability of the device and its capacity to receive and process the data.

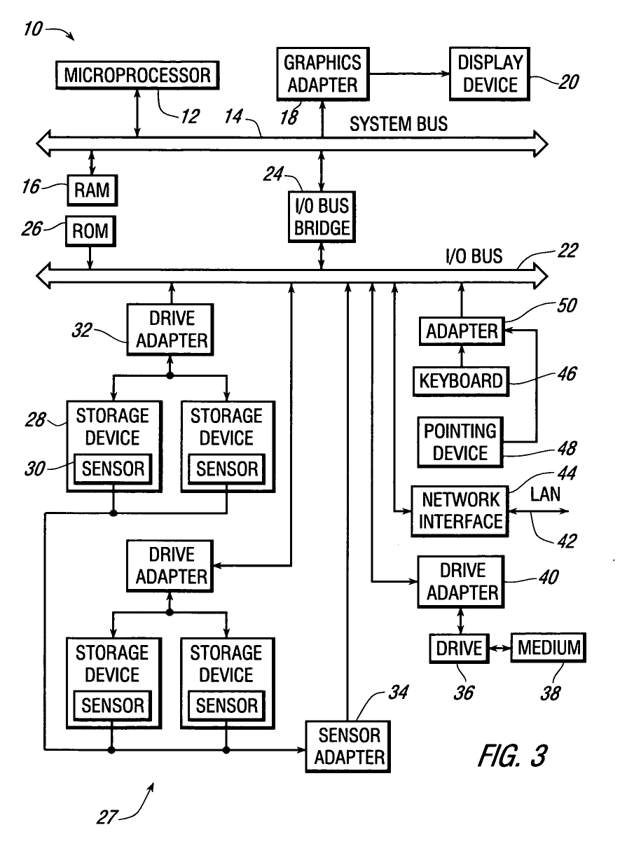

FIG. 2 is a block diagram of data storage apparatus built in accordance with a first embodiment of the invention. The data source 5 can provide data to any of a number of storage devices 6, each of which is provided with an associated thermal sensor 7 providing a signal indicating the operating temperature of the storage device 6. Again, the thermal sensors 7 are connected to control means 8, which selectively enables the storage devices 6 to receive data. In this embodiment, identical data is redundantly recorded in two of the storage devices 6, so that the data can be subsequently recovered in the event of the failure of one of the storage devices 6. In the absence of such a storage device failure, previously recorded data is read from either of the two storage devices 6 in which it has been recorded, being returned to the data source 5, which additionally acts as a receiver of stored data. The control means 8 determines which of the storage devices 6 are used for storing data and for reading previously stored data.

In accordance with a first version of this embodiment, data is written to the coolest two storage devices 6 that are determined to be available to receive the data. Then, the data is read from the cooler of the two devices in which it has been recorded.

In accordance with a second version of this embodiment, the storage devices the storage devices 6 are arranged in pairs, with the same data being written to both of the storage devices 6 in a pair. The data is written to the pair of storage devices 6 determined to be available to receive the data, for which the hotter of the two storage devices 6 in the pair is determined to be the coolest of the hotter devices within each of the pairs. In this way, the temperature of the hotter of the two devices in each pair is used to determine which pair of devices is to be written to, so that data will not be written to the hottest of the devices in the entire group of devices. For such a determination to be made, there must be at least four storage devices 6, forming two pairs. If there is only one pair, data will always be written to both of its devices. Then, when the data is to be read, it is read from the cooler of the two devices.

In accordance with a third version of this embodiment, the storage devices the storage devices 6 are again arranged in pairs, with the same data being written to both of the storage devices 6 in a pair. Data is written to the storage devices in a conventional manner, without making the recording of data dependent on the determination of which devices are cooler. Then, when data is to be read, it is read from the cooler of the two devices in which it has been written.

In FIG. 1, optional elements are shown with dashed lines. In other embodiments of the invention, data is passed through the devices 2 to an optional data receiver 9. For example, in accordance with a second embodiment of the invention, the devices 2 are communication adapter circuits through which data signals are passed to a server. In accordance with a third embodiment of the invention, each of the devices 2 is a computer system connected to a server over a LAN (local area network).

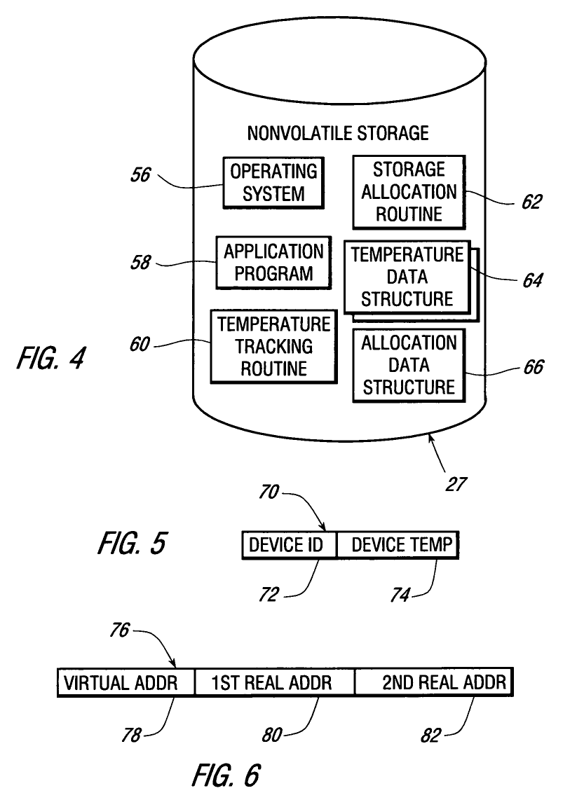

FIG. 3 is a block diagram of a computer system 10 configured to operate in accordance with the invention for the storage and retrieval of data. FIG. 4 is a block diagram showing elements within the portable computer system 10, which includes the microprocessor 12 connected to a system bus 14 for the transfer of data, along with a RAM (random access memory) 16, and a graphics adapter 18, which provides signals to drive a display device 20. The system bus 14 is also connected to an I/O (input/output) bus 22 through an I/O bus bridge 24, which relays information between the buses 14, 22, making data transformations as required. A ROM (read-only memory) 26, connected to the I/O bus 22, stores instructions for initializing the operation of the computer system 10 when power is turned on. Nonvolatile storage 27 of data and program instructions is provided through the use of a number of data storage devices 28, in the form of hard disk drives, connected to the I/O bus 22 through one or more drive adapters 32. The data storage devices 28 are redundant, with a capability being provided for data to be written to any of the devices 28. In accordance with a preferred version of the invention, each of the data storage devices 28 is provided with a thermal sensor 30 sensing the temperature of an area expected to undergo heating during use of the system 10 and of the drive 28. For example, the thermal sensor 30 may be mounted to provide a signal indicating the temperature of a drive motor or of a spindle bearing within the hard disk drive 28, in the manner described in U.S. Pat. No. 5,732,215, the disclosure of which is incorporated herein by reference. Output signals from each of the thermal sensors 30 are provided as input signals to a sensor adapter circuit 34, which in turn generates signals transmitted along the I/O bus 22 to provide indications of the temperatures measured by the thermal sensors 30.

Data and instructions for programs executing within the microprocessor 12 are read from nonvolatile storage within the data storage devices to be loaded into RAM 16. The portable computer system 10 additionally includes a drive 36 for reading information from a removable medium 38, such as an optical disk, with the drive 36 being connected to the I/O bus 22 through a drive adapter 40. For example, a LAN (local area network) 42 is additionally connected to the I/O bus 22 through a network interface circuit 44.

Program instructions to be executed within the portable computer system 10 may be loaded from the removable medium 38, which forms an example of a computer readable medium, through the drive 36, to be stored in nonvolatile storage within the data storage devices 28 or to be stored for execution within the RAM 26, with magnetic storage within the devices 28 and the RAM 16 additionally forming examples of computer readable media. Alternately, such instructions can be received in the form of a computer data signal embodied on a carrier wave from the LAN 42 through the network interface circuit 44. User inputs to the portable computer system 10 are provided through a keyboard 46 and through a pointing device 48, such as a mouse or touch pad, with the keyboard 46 and pointing device 48 both being attached to the I/O bus 22 through an adapter 50.

In accordance with a preferred version of the invention, at least some of the data stored within non-volatile storage 27 is stored redundantly, within two of the data storage devices 28, so that the data will not be lost if one of the drives 28 fails. During normal operation of the computer system 10, such data can be read from either of the two data storage devices 28 in which it is stored. This capability is used to provide a way to prevent overheating of the data storage devices 28 by reading data from the cooler of the two drives on which it is stored whenever possible. This method is particularly effective when it is used in an application in which data, once written, is read many times, so that most of the use of the data storage devices 28 is encountered during read operations. An example of such an application is an Internet web server, in which the data describing a web page is read for transmission may times after it is written. The temperatures measured by the sensors 32 may additionally be used to determine data storage devices 28 to which data is written, providing an additional means for balancing the operating temperatures within the data storage devices 28 operate. For the data storage devices 28 to be allocated for storing data according to the temperature of the devices 28, there must be at least three such devices 28.

FIG. 4 is a block diagram of information, in the form of data and program instructions, stored within the non-volatile storage 27 of the computer system 10. Preferably, like other information stored within the non-volatile storage 27, the data and program instructions particularly indicated in this figure are stored redundantly within different data storage devices 28, so that the information is not lost in the event of a failure of one of the data storage devices 28. The information stored within non-volatile storage 27 includes program instructions for an operating system 56 and one or more application programs 58.

In accordance with the invention, the information stored within nonvolatile storage 27 further includes a temperature tracking routine 60 and a storage allocation routine 62. The temperature tracking routine 60 receives data on a periodic basis from each of the sensors 30 to track the temperature of the data storage device 28 associated the sensor 30 and writes data indicating the measured temperature to a temperature data structure 64, additionally stored within non-volatile storage 27. The storage allocation routine 62 is called when there is a request to read from the data storage devices 28 and whenever there is a request to write data to one of these data storage devices 28. Such data is written redundantly, in two different drives 28. Therefore, when the storage allocation is called to read data, it examines an allocation data structure 66 stored within non-volatile storage 27 to determine the locations of the two data storage devices 28 where the data to be read can be found, and then examines the temperature data structure 64 to determine which of these two data storage devices 28 is cooler. Then the data is then read from the cooler one of these two devices.

Preferably, two temperature data structures 64 are stored within nonvolatile storage 27, with data periodically being written to the two data structures 64 in an alternating fashion so that, while data is being written to one of the data structures 64 by the temperature tracking routine 60, the other data structure 64 can be used by the storage allocation routine 62 to determine which drive that can be used to read or write data is the coolest. Either or both of the routines 60, 62 may be subroutines called by another program or routine and returning to the calling routine upon completion.

FIG. 5 is a pictographic view of a data record 70 within a first version of each of the temperature data structures 64 within nonvolatile storage 27. There is one data record 70 for each of the data storage devices 28 for which an operating temperature is tracked by the temperature tracking routine 60. The data record 70 includes a first data field 72, in which data identifying the data storage device 28 associated with the particular data record 70 is stored, and a second data field 74, in which data representing the temperature last measured at the data storage device 28 by means of the temperature tracking routine 60 is stored. Preferably, the data records 70 are stored within the temperature data structure 64 in a sequential order representing variations in the levels of temperatures measured, for example, with the data record 70 associated with the coolest data storage device 28 being stored at the beginning of the temperature data structure 64 and with the data record 70 associated with the hottest data storage device 28 being at the end of the temperature data structure 64. This kind of sequential ordering of the data record 70 is provided to simplify the selection of the coolest drive during operation of the storage allocation routine 62.

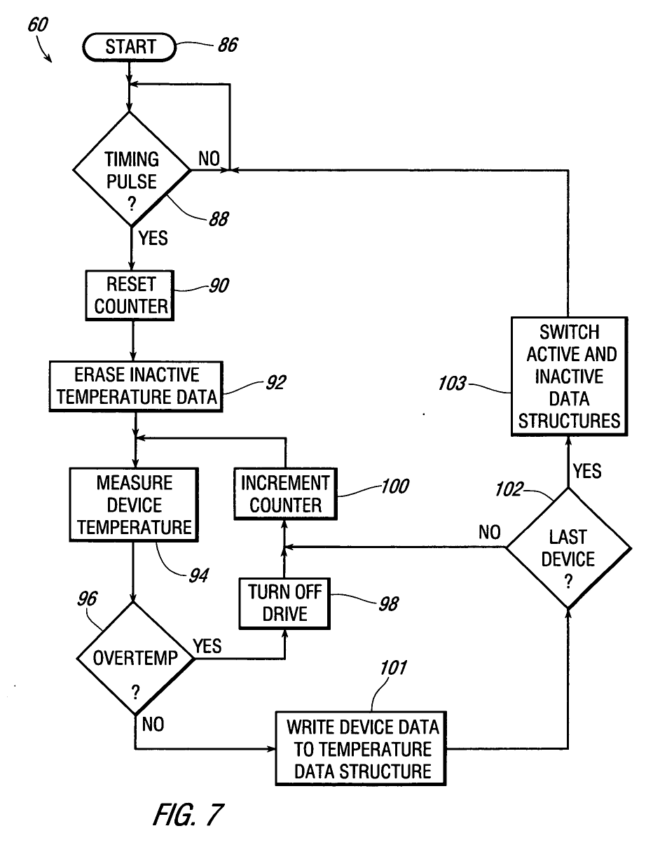

FIG. 6 is a pictographic view of a data record 76 within a first version of the allocation data structure 66 within nonvolatile storage 27. The allocation data structure 66 includes a data record 76 for each time data is stored at a different location within the data storage devices 28 through operation of the storage allocation routine 62. The data record 76 includes a first data field 78 storing a virtual address associated with the data, which is provided so that an application program 58 executing within the computer system 10 can locate the stored data. The data record 76 additionally includes a first real address data field 80 storing data identifying the location of the data within the first data storage device 28 in which the data is stored and a second real address data field 82 storing data identifying the location of the data within the second data storage devices 28 in which the same data is stored.

FIG. 7 is a flow chart of processes occurring during the execution of the temperature tracking routine 60, for which instructions are stored in nonvolatile storage 27, within the computer system 10. Preferably the temperature tracking routine 60 is started in step 86 during an initialization routine executing within the computer system 10 after power is turned on within the system 10, with the routine 60 then continuing to run until the system 10 is shut down. Since the process of shutting down can occur at any time during the operation of the routine 60 without causing damage, a specific point for ending the routine 60 is not shown in the figure.

After starting in step 86, the temperature tracking routine 60 proceeds to step 88 to wait for a pulse indicating that it is time to determine the operating temperature of each of the data storage devices 28. When it is determined that this pulse is occurring, the routine 60 proceeds to step 90, in which a device counter is reset to start the process of recording temperatures with the first drive 28 to be examined. Then, in step 92, data within the inactive temperature data structure 64 us erased so that this data structure 64 can be used to store the new temperature data. Then, in step 94, the temperature of the data storage 28 indicated by the device counter is measured. Next, in step 96, it is determined whether the temperature measured in step 94 indicates that an “overtemp” condition has been reached, in which the particular data storaged device 28 can continue to operate reliably and without damage. If such an overtemp condition has been reached, the drive device 28 is turned off in step 98. Then, in step 100, the device counter is incremented so that the temperature of the next drive device 28 is measured.

On the other hand, if it is determined in step 96 that an overtemp condition has not been reached, the routine 60 proceeds to step 101, in which data identifying the data storage device 28 for which a temperature has last been measured in step 94 and describing the temperature value that was measured is written to the inactive temperature data structure 64. After the data for this device 28 has been written in step 101, the temperature tracking routine 60 proceeds to step 102, in which it is determined whether the device 28 that has been most recently measured in step 94 is actually the last device for which such a measurement is to be made. If it is not, the routine 60 returns to step 100 to increment the device counter, so that the temperature of the next device 28 is measured in step 94, with this process continuing until it is determined in step 102 that the temperature of the last device 28 has been measured. Then, the active and inactive data structures are switched in step 103. This may be accomplished by switching a pointer that points to the active data structure. Then, the routine 60 returns to step 88 to wait for the next timing pulse, with the most recently measured temperatures being available in the active temperature data structure 64.

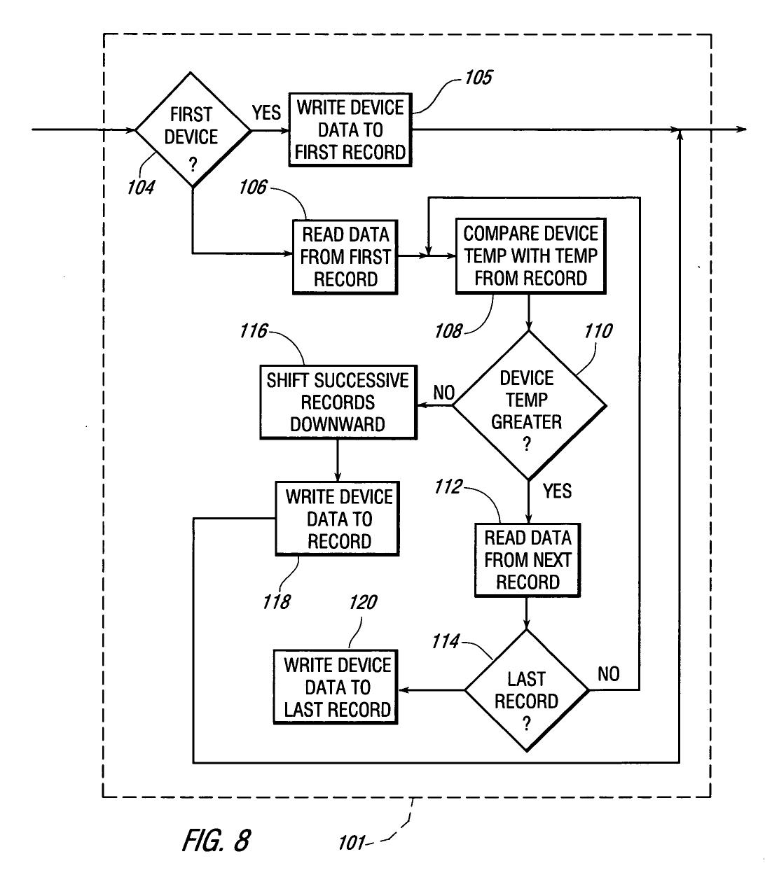

FIG. 8 is a flow chart of processes occurring during step 101 of FIG. 7, in which data identifying the data storage device 28 for which a temperature has last been measured in step 94 and describing the temperature value that was measured is written to the inactive temperature data structure 64. In step 104, a further determination is made of whether the temperature of the first data storage device has been measured in step 94. If it has, the device data, including information identifying the particular data storage device 28 and its measured operating temperature, is written to the first data record 70 within the inactive temperature data structure 64 in step 105.

If it is determined in step 104 that the data storage device 28 for which an operating temperature has been most recently measured in step 94 is not the first device for such a measurement is made, the temperature tracking routine 60 proceeds to step 106, in which the data from the first data record 70 in the inactive temperature data structure 64 is read. Then, in step 108, the device temperature most recently measured in step 94 is compared with the temperature most recently read from the inactive data structure 64. If the device temperature is greater than the temperature read from the data structure, the routine 60 proceeds from step 110 to read the temperature from the next data record 70 within the inactive data structure 64. This process continues until it is determined in step 114 that data has been read from the last data record 70 within the data structure 64, with the routine 60 returning each time data is read from a new data record 70 to step 108 to compare the device temperature most recently measured in step 94 with the temperature most recently read from a data record 70.

Whenever it is determined in step 108 that the device temperature is not higher than the temperature read from the data record, the routine 60 proceeds to step 116, in which the data records 70 within the inactive temperature data structure 64 below the data record 70 that has just been read are shifted downward to provide a space for writing data associated with the device for which a temperature has been most recently measured in step 94. (This process of shifting data may be achieved by actually moving data or by adjusting a pointer pointing to the location of stored data.) Then, in step 118, the data associated with the device for which a temperature has most recently been measured in step 94 is written in the space provided in the data structure 64 in step 116. If it is determined in step 114 that the data for the last record within the inactive temperature data structure 64 has been read, the data for the device for which a temperature has most recently been measured in step 94 is written in step 120 to form a new record 70 at the end of this data structure 64.

Thus, the data associated with the data storage device 28 that has most recently been measured in step 94 is inserted within or appended to the data within the inactive temperature data structure 64 in an order of ascending device temperature, with data for the coolest device 28 being stored within the first data record 70, and with data for the hottest device 28 being stored within the last data record 70.

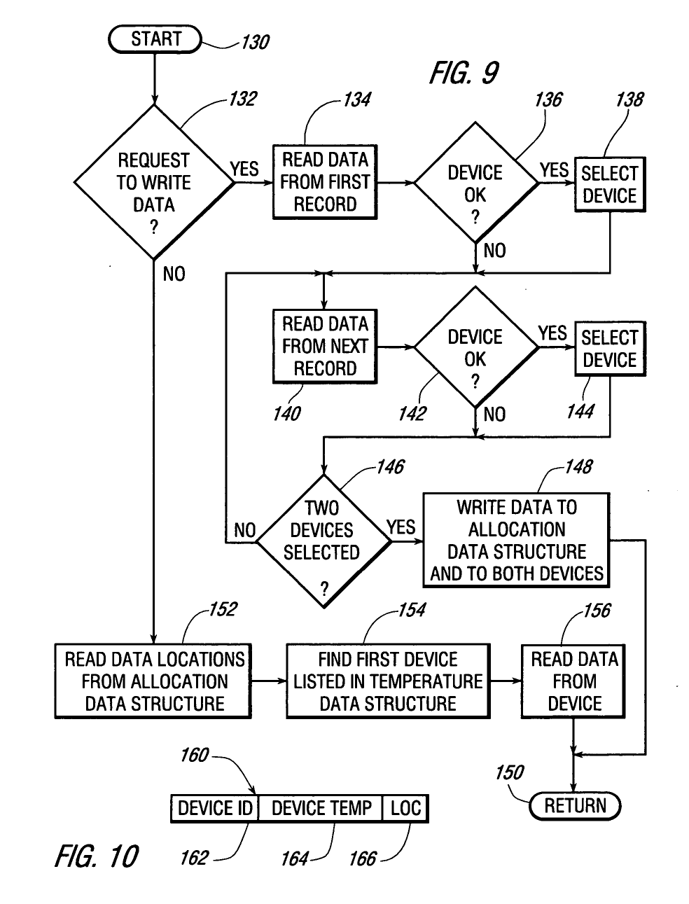

FIG. 9 is a flow chart of processes occurring during the execution of the storage allocation routine 62, for which instructions are stored in nonvolatile storage 27, within the computer system 10. This routine 62 is started in step 130 after being called by an application program 58 or by the operating system 56 to write data to one of the data storage devices 28, or to read data from one of these drives 28. After starting in step 130, a determination is made in step 132 of whether a request has been made to write or read data. If a request has been made to write data, the first data record 70 within the active temperature data structure 64 is read in step 134 to determine the device 28 that was determined to be the coolest of the devices 28 during the last temperature measurements taken by the temperature tracking routine 60. Then, in step 136, a further determination is made of whether the device 28 is available to have the data written to it. For example, such a determination may include determining that the device 28 is functioning properly and that there is sufficient space for left for recording the data. If it is determined in step 136 that the device is ready, the device is selected in step 138 for recording the data.

Since two of the devices 28 must be selected for recording data, the storage allocation routine 62 proceeds to step 140 to read data from the next data record 70 within the active temperature data structure 64 to determine the device 28 that was determined to be the next coolest of the devices 28 during the last temperature measurements taken by the temperature tracking routine 60. Then, in step 142, a further determination is made of whether this device is available to have the data written to it. If it is ready, this next device 28 is selected in step 144. In either case, the routine 62 proceeds to step 146, in which a determination is made of whether two data storage devices 28 have been selected. If they have not, the routine 62 returns to step 140 to read data from the next data record 70. If two devices 28 have been selected, in step 148, the data to be written is written to the selected devices 28, and data identifying the selected devices 28 is written to a new data record 76 within the allocation data structure 68, so that the appropriate devices 28 can be accessed later when the data is to be read. After this data is stored in step 148, the storage allocation routine 62 ends, returning to the calling routine in step 150.

On the other hand, if it is determined in step 132 that the a request has been made to read data instead of to write data, the storage allocation routine 62 proceeds to step 152, in which data is read from the data record 76 within the allocation data structure 68 corresponding to the data to be read to determine the identities of the two data storage devices 28 in which the data to be read has been stored. Then, in step 154, the first of the devices identified in step 152 is found within a data record 70, with the examination of the data records 70 beginning with the first data record 70 within the active temperature data structure 64 and continuing with successive data records 70, so that the first of the devices 28 found is the cooler of the two such devices 28. This is achieved due to the order in which data records 70 are stored in the temperature data structure 64, which has been explained in detail in reference to FIG. 8. Then, in step 156, the routine 62 ends, returning to the calling routine.

In accordance with a second version of the first embodiment of the invention, the data storage devices 28 within nonvolatile storage 27 are arranged in pairs, with identical data being written to both of the devices 28 in a pair.

FIG. 10 is a pictographic view of a data record 160 stored within each of the temperature data structures 64 within nonvolatile storage 27 in accordance with this second version of the first embodiment of the invention. The data record 160 includes a first data field 162 in which data identifying the pair of devices 28 is stored, a second data field 164, in which data representing the temperature last measured in the hotter device of the pair of data storage devices 28, and a third data field 166, in which a location bit identifying which of device within the pair of data storage devices 28 is the hotter of the pair.

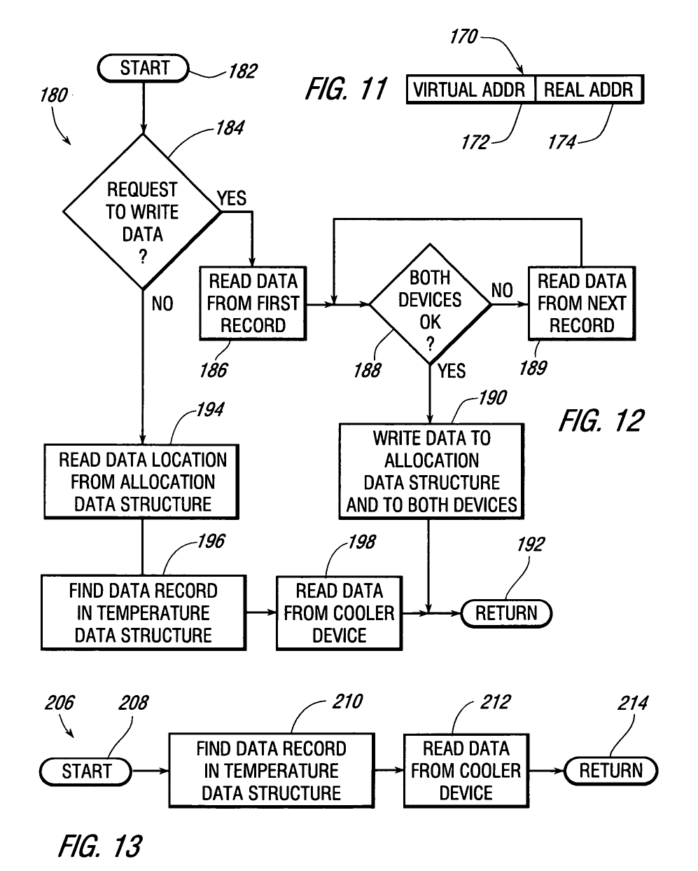

FIG. 11 is a pictographic view of a data record 170 stored within the allocation data structure 66 within nonvolatile storage 27 in accordance with the second version of the invention. The data record 170 includes a first data field 172 storing a virtual address associated with data stored in both of the data storage devices identified within a real address indicated by data stored within a second data field 174.

The processes occurring during the execution of the temperature tracking routine 60 in accordance with the second version of the first embodiment of the invention are generally as described above in reference to FIG. 7, with the device counter reset in step 90 and incremented in step 100 referring to an associated pair of data storage devices 28 to which the same data is written. Thus, in step 94, the temperature of both of these associated devices 28 is measured. In step 98, one of the associated devices 28 may be turned off if an “overtemp” condition is reached within the device 28, with the other device 28 then having data read therein but not written thereto. In step 110, the higher of the two device temperatures most recently measured for the associated pair of devices 28 is compared to the device temperature previously stored in a data record 160. When the device data is written to the data record 170 in step 118, only the higher device temperature is stored in the second data field 164, and a location bit indicating the hotter of the two devices 28 is written to the third field 166. In this way, the temperature data structure 64 is configured to include data records 170 arranged in a sequence according to increasing levels of the temperature of the hotter of the two devices 29 within each pair of devices represented by one of the records 170.

FIG. 12 is a flow chart of processes occurring during execution of a second version 180 of a storage allocation routine stored in nonvolatile storage 27 for allocating data storage in accordance with the second version of the first embodiment of the invention. This routine 180 is started in step 182 after being called by an application program 58 or by the operating system 56 to write data to one of the data storage devices 28, or to read data from one of these devices 28. After starting in step 182, a determination is made in step 184 of whether a request has been made to write or read data. If a request has been made to write data, the first data record 160 within the active temperature data structure 64 is read in step 186 to determine the associated pair of devices 28 that was determined to be the coolest of the devices 28 during the last temperature measurements taken by the temperature tracking routine 60. Then, in step 188, a further determination is made of whether both the devices 28 are ready to have the data written to them. For example, such a determination may include determining that the devices 28 are functioning properly and that there is sufficient space for left for recording the data. If it is determined in step 188 that either or both of the devices 28 are not ready, data is read from the next data record 160 in step 189 to find the pair of devices 28 having the next coolest drive as its hottest drive. When it is determined in step 188 that both the devices 28 are ready, the data to be written is written to the devices 28 and data identifying the devices 28 is written to a new data record 170 within the allocation data structure 68, so that the appropriate devices 28 can be accessed later when the data is to be read. After this data is stored in step 190, the storage allocation routine 62 ends, returning to the calling routine in step 192.

On the other hand, if it is determined in step 184 that the a request has been made to read data instead of to write data, the storage allocation routine 180 proceeds to step 194, in which data is read from the data record 170 within the allocation data structure 68 corresponding to the data to be read to determine the identities of the two data storage devices 28 in which the data to be read has been stored. Then, in step 196, the data record 160, associated with both of the drive devices 28 storing the data to be read, is found within the temperature data structure 64, with the cooler of these two devices being identified by the location bit stored in the third data field 166 of this data record 160. Next, the requested data is read from the cooler of these two devices in step 198, before the routine 180 ends in step 192.

In accordance with a third version of the first embodiment of the invention, data is redundantly stored within pairs of the drive devices 28 in a conventional manner, without being stored in locations determined according to the temperatures of the various devices. Then, in response to a request to read the previously recorded data, the data is read from the cooler of the two drive devices on which it has been recorded. While some of the effectiveness of the first and second versions of the first embodiment, described above, in directing usage to the coolest devices are thus lost, significant simplification in operation may be achieved. This third version has a particular advantage in an application in which data is written once to be read many times, such as in the storage of data for an Internet web site, in which data written once is read many times in response to client browsers requesting the data.

For example, data is written to paired devices 28, as in the second version of the first embodiment, but without regard to first finding the pair of devices 28 in which the hotter of the two paired devices 28 is the coolest such device within non-volatile data storage 27, to subsequently be read from the cooler of the two devices 28 within the pair. The temperature tracking routine operates generally as described above in reference to FIGS. 5 and 8 to generate data for a data record 160 for each of the pairs of devices 28. However, since temperature data is used merely to determine which of two paired devices is to be used for reading previously recorded data, it is not necessary to arrange the order in which the data records 160 are placed within the temperature data structure 64, as described above in reference to FIG. 8. Thus, step 101 of FIG. 7 merely includes writing data for the pair of devices 28 to the next data record 160 within the inactive temperature data structure 64.

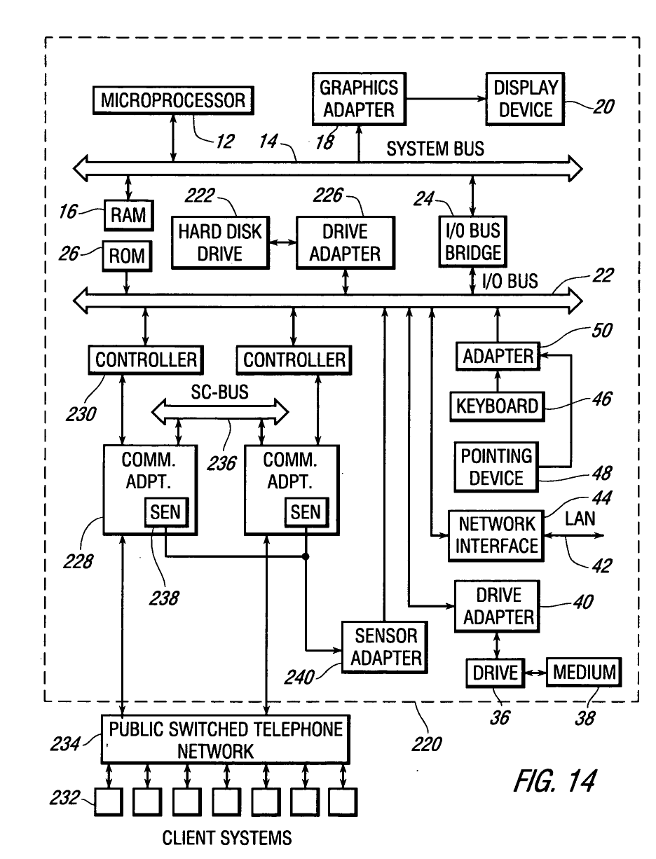

FIG. 13 is a flow chart of processes occurring during execution, in accordance with the third version of the first embodiment of the invention, of a third version of a storage allocation routine 206 stored in nonvolatile storage 27. Since the data is redundantly stored in locations determined by conventional means, the routine 206 is only required to cause the data to be read from the cooler of the two data storage devices 28 in which it has been stored. Thus, after starting in step 208 after being called in response to a request to read data, the routine 206 finds, in step 210, the data record 160 associated with the drives devices 28 in which the data has been stored. Then, in step 212, the data is read from the cooler of the two drives, as indicated within the third data field 166 of the data record 160. After the data is read, the routine 206 ends in step 214, returning to the calling routine.

FIG. 14 is a block diagram of a system including a remote network server 220 built to operate in accordance with a second embodiment of the invention. The server 220 includes a number of conventional elements, which are similar to elements previously discussed in reference to FIG. 3, which are therefore accorded like reference numbers. The server 220 also includes nonvolatile storage in the form of a data storage device 222, which may be conventional, connected to the I/O bus 22 by means of a drive adapter 226. The server 220 further includes at least two communication adapter circuits 228, each of which is connected to the I/O bus 22 by means of a controller 230. Each of the communications adapter circuits 228 is connected to a number of client systems 232 through the public switched telephone network 234. The remote network server 220 is used to connect various client systems 232 with the LAN 42 or with another network, such as the Internet, that is reached over the LAN 42. The communication adapter circuits 228 are additionally connected to one another over an SC-bus 236, through interfaces configured according to the SCSA (Signal Computing System Architecture) requirements, so that a call from a client system 232 can be routed through the communication adapter circuit 228 at which it is received, or, alternately, through another one of the communication adapter circuits 228, having been routed along the SC-bus 236.

A remote network server including multiple communication adapter circuits connected to a network such as the public switched telephone network and to one another through an SC bus to direct calls among the communication adapter circuits is described in U.S. Pat. No. 6,195,359, the disclosure of which is incorporated herein by reference.

For operation in accordance with the present invention, each of the communication adapter circuits 228 includes a thermal sensor 238, located to sense the operating temperature of a temperature-sensitive region within the circuit 228. The thermal sensors 238 are connected to the I/O bus 22 through a sensor adapter circuit 240.

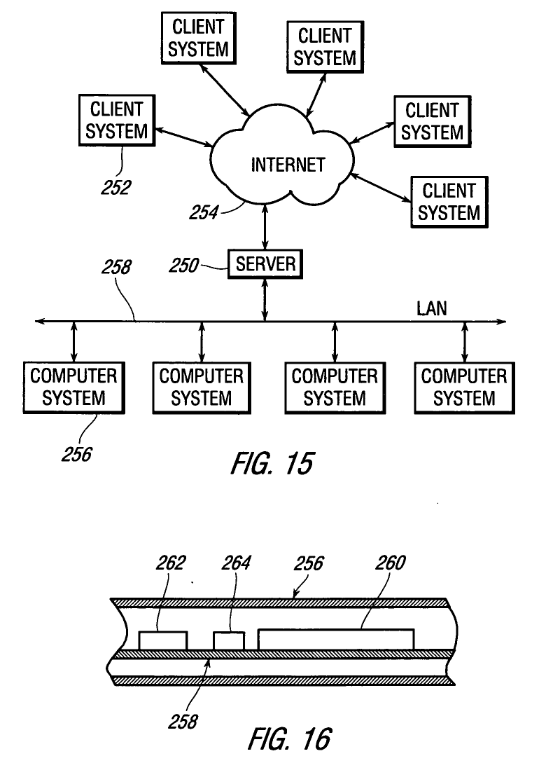

FIG. 15 is a block diagram of a system including a server 250 built in built to operate in accordance with a third embodiment of the invention. The server 250 is connected to receive calls from a number of client systems 252 through a wide area network 254, such as the Internet. The server 250 is additionally connected to a number of computer systems 256 through a LAN 258.

FIG. 16 is a fragmentary cross-sectional elevation of a computer system 256 within the system of FIG. 15. Each of the computer systems 256 includes a circuit board 258 having a microprocessor 260 and a number of other circuit modules 262. For operation in accordance with the third embodiment of the invention, the circuit board 258 also includes a thermal sensor 264 located in a region, such as adjacent to the microprocessor 260, where the operating temperature of a thermally sensitive portion of the computer system 256 can be sensed.

The server 250 periodically receives data indicating the operating temperature of each of the computer systems 256, maintaining a temperature tracking data structure similar to the temperature tracking data structure 64, described above in reference to FIG. 4. A device allocation routine, similar to the storage allocation routine 62 executes within the server 250 to determine that the coolest available computer system 256 is allocated to process data. In this regard, it is understood that the storage allocation routine 62, as previously discussed in detail, is a form of a device allocation routine for allocating a data processing device to process data according to its operating temperature.

While the invention has been described in its preferred forms or embodiments with some degree of particularity, it is understood that this description has been given only by way of example, and that many variations can be achieved without departing from the spirit and scope of the invention, as defined within the appended claims.

What is claimed is:

1. Data processing apparatus comprising:
a data source providing data for processing within the data processing apparatus;
a plurality of data processing devices connected to the data source to receive data for processing;
a plurality of thermal sensors, wherein each of the thermal sensors measures an operating temperature of a device in the plurality of data processing devices and produces a temperature signal indicating the operating temperature measured; and
a control device operating in response to the temperature signal from each of the thermal sensors to select a data processing device within the plurality of data processing devices having an operating temperature cooler than at least one other data processing device within the plurality of data processing devices and to cause data from data source to be processed within a selected data processing device.

2. The data processing apparatus of claim 1, wherein the control device includes:
a microprocessor programmed to execute instructions of a temperature tracking routine generating a temperature tracking data structure including data indicating an operating temperature measurement within each of the data processing devices, and to execute instructions of a device allocation routine determining which data processing device processes data from the data source; and
data storage holding the temperature tracking data structure.

3. The data processing apparatus of claim 2, wherein
the temperature tracking data structure includes a data record associated with each data processing device within the plurality of data processing devices,
data records within the temperature tracking data structure are arranged in order of measured operating temperatures of the data processing devices with which the data records are associated, and
data records are read by the device allocation routine in order of their arrangement within the temperature tracking data structure, starting with a data record associated with a data processing device within the plurality of data processing devices for which a coolest operating temperature has been measured.

4. The data processing apparatus of claim 2, wherein the temperature tracking routine causes the microprocessor to periodically perform a temperature tracking method including, for each data processing device within the plurality of data processing devices, measuring the device temperature and writing device data identifying the device and the device temperature to the temperature tracking data structure.

5. The data processing apparatus of claim 4, wherein
the data storage additionally holds another temperature tracking data structure,
the device allocation routine causes data to be read from an active temperature tracking data structure within the data storage,
the temperature tracking routine causes data to be written to an inactive temperature tracking data structure within the data storage,
when data for each data processing device within the plurality of data processing devices has been written to the inactive temperature tracking data structure, the inactive temperature tracking data structure becomes inactive, and the previously active data structure becomes inactive.

6. The data processing apparatus of claim 4, wherein, during performance of the temperature tracking method,
data for a first data processing device is written to a data record at a beginning of the temperature tracking data structure,
an operating temperature for each data processing device measured after the operating temperature of the first data processing device is compared with an operating temperature recorded in each data record in the temperature tracking routine in an order in which data records have been written until it is determined that the operating temperature for the data processing device is hotter than the operating temperature recorded in the data record,
in response to determining that the operating temperature of the data processing device measured after the operating temperature of the first data processing device is hotter than the operating temperature recorded in the data record, the data record and subsequent data records are shifted toward an end of the temperature tracking data structure, and data corresponding to the data processing device is written to the position of the data record, and
if it is determined that the operating temperature of a data processing device is hotter than each of the operating temperatures recorded in the data record, data corresponding to the data processing device is written to a position at the end of the temperature tracking data structure.

7. The data processing apparatus of claim 1, wherein the control device selects a data processing device having the coolest operating temperature within the plurality of data processing devices.

8. The data processing apparatus of claim 1, wherein the control device determines whether a data processing device is available for use and selects the data processing device having the coolest operating temperature that is available for use.

9. The data processing apparatus of claim 1, wherein the control device causes data from the data source to be transmitted to the selected data processing device.

10. The data processing apparatus of claim 1, wherein the control device enables data processing operations within the selected data processing device.

11. The data processing apparatus of claim 1, wherein
each of the data processing devices is a data storage device in a plurality of data storage devices,
data from the data source is stored in two data storage devices within the plurality of data storage devices.

12. The data processing apparatus of claim 11, wherein
the plurality of data storage devices includes at least three data storage devices, and
data from the data source is stored in a data storage device determined to be a coolest available data storage device within the plurality of data storage devices and additionally in a data storage device determined to be a second coolest available data storage device within the plurality of data storage devices.

13. The data processing apparatus of claim 12, wherein data to be read is read from a data storage device determined to be the cooler of two data storage devices in which the data to be read is stored.

14. The data processing apparatus of claim 12, wherein the control device includes:
a microprocessor programmed to execute instructions of a temperature tracking routine generating a temperature tracking data structure including data indicating an operating temperature measurement within each of the data data storage devices, and to execute instructions of a storage allocation routine determining which data data storage device stores data from the data source; and
data storage holding the temperature tracking data structure.

15. The data processing apparatus of claim 14, wherein
the temperature tracking data structure includes a data record associated with each data storage device within the plurality of data storage devices,
data records within the temperature tracking data structure are arranged in order of measured operating temperatures of the data storage devices with which the data records are associated, and
data records are read by the storage allocation routine in order of their arrangement within the temperature tracking data structure, starting with a data record associated with a data storage device within the plurality of data storage devices for which a coolest operating temperature has been measured.

16. The data processing apparatus of claim 14, wherein the temperature tracking routine causes the microprocessor to periodically perform a temperature tracking method including, for each data storage device within the plurality of data storage devices, measuring the device temperature and writing device data identifying the device and the device temperature to the temperature tracking data structure.

17. The data processing apparatus of claim 16, wherein
the data storage additionally holds another temperature tracking data structure,
the storage allocation routine causes data to be read from an active temperature tracking data structure within the data storage,
the temperature tracking routine causes data to be written to an inactive temperature tracking data structure within the data storage,
when data for each data processing device within the plurality of data processing devices has been written to the inactive temperature tracking data structure, the inactive temperature tracking data structure becomes inactive, and the previously active data structure becomes inactive.

18. The data processing apparatus of claim 16, wherein, during performance of the temperature tracking method,
data for a first data storage device is written to a data record at a beginning of the inactive temperature tracking data structure,
an operating temperature for each data storage device measured after the operating temperature of the first data storage device is compared with an operating temperature recorded in each data record in the temperature tracking routine in an order in which data records have been written until it is determined that the operating temperature for the data storage device is hotter than the operating temperature recorded in the data record,
in response to determining that the operating temperature of the data storage device measured after the operating temperature of the first data storage device is hotter than the operating temperature recorded in the data record, the data record and subsequent data records are shifted toward an end of the temperature tracking data structure, and data corresponding to the data storage device is written to the position of the data record, and
if it is determined that the operating temperature of a data storage device is hotter than each of the operating temperatures recorded in the data record, data corresponding to the data storage device is written to a position at the end of the temperature tracking data structure.

19. The data processing apparatus of claim 17, wherein
the data storage additionally holds an allocation data structure, and
in response to a request to write data to be stored, the storage allocation routine performs steps of:
reading data from the data record at the beginning of the active temperature tracking data structure, determining if the data storage device with which the data record is associated is available, and selecting the data storage device in response to determining it is available;
reading data from successive data records following the data record at the beginning of the active temperature tracking data structure, determining if the data storage device with which the data record is associated is available, and selecting the data storage device in response to determining it is available, until a second data storage device has been selected; and
writing data to the allocation data structure identifying the selected data storage devices and writing the data to be stored to the selected data storage devices.

20. The data processing apparatus of claim 19, wherein, in response to a request to read stored data, the storage allocation routine performs steps of:
reading locations of the stored data from the storage allocation data structure;
reading data from successive data records within the active temperature tracking data structure to find a data storage device in which the stored data is stored; and
reading the stored data from the data storage device.

21. The data processing apparatus of claim 11, wherein
the plurality of data storage devices includes at least four data storage devices,
the data storage devices are arranged in pairs of data storage devices, and
data is from the data source is written to each of the data storage devices within an available pair of data storage devices having a hotter data storage device within the pair of data storage devices that is determined to be cooler than the hotter data storage device within each of the other available pairs of data storage devices within the plurality of data storage devices.

22. The data processing apparatus of claim 21, wherein data to be read is read from a data storage device determined to be the cooler of two data storage devices in which the data to be read is stored.

23. The data processing apparatus of claim 21, wherein the control device includes:
a microprocessor programmed to execute instructions of a temperature tracking routine generating a temperature tracking data structure including data indicating an operating temperature measurement within each of the data storage devices, and to execute instructions of a storage allocation routine determining which data storage device stores data from the data source; and
data storage holding the temperature tracking data structure.

24. The data processing apparatus of claim 23, wherein
the temperature tracking data structure includes a data record associated with each of the pairs of data storage devices within the plurality of data storage devices,
data records within the temperature tracking data structure are arranged in order of measured operating temperatures of the hotter data storage device within each of the pairs of data storage devices with which the data records are associated, and
data records are read by the storage allocation routine in order of their arrangement within the temperature tracking data structure, starting with a data record associated with a pair of data storage devices within the plurality of data storage devices for which a coolest operating temperature for the hotter data storage device within the pair has been measured.

25. The data processing apparatus of claim 23, wherein the temperature tracking routine causes the microprocessor to periodically perform a temperature tracking method including, for each pair of data storage device within the plurality of data storage devices, measuring the device temperature and writing device data identifying the pair of data storage devices, the device within the pair of devices for which the hotter temperature is measured, and the device temperature of the device within the pair of devices for which the hotter temperature is measured, to the temperature tracking data structure.

26. The data processing apparatus of claim 23, wherein
the data storage additionally holds another temperature tracking data structure,
the storage allocation routine causes data to be read from an active temperature tracking data structure within the data storage,
the temperature tracking routine causes data to be written to an inactive temperature tracking data structure within the data storage,
when data for each data processing device within the plurality of data processing devices has been written to the inactive temperature tracking data structure, the inactive temperature tracking data structure becomes inactive, and the previously active data structure becomes inactive.

27. The data processing apparatus of claim 25, wherein, during performance of the temperature tracking method,
data for a first pair of data storage devices is written to a data record at a beginning of the inactive temperature tracking data structure,
an operating temperature for a hotter data storage device within each pair of data storage devices measured after the first pair of data storage devices is compared with an operating temperature recorded in each data record in the temperature tracking routine in an order in which data records have been written until it is determined that the operating temperature for the hotter data storage device within the pair is hotter than the operating temperature recorded in the data record,
in response to determining that the operating temperature of the pair of data storage devices measured after the first pair of data storage devices is hotter than the operating temperature recorded in the data record, the data record and subsequent data records are shifted toward an end of the temperature tracking data structure, and data corresponding to the pair of data storage devices is written to the position of the data record, and
if it is determined that the operating temperature of the hotter data storage device within the pair of data storage devices is hotter than each of the operating temperatures recorded in the data record, data corresponding to the pair of data storage devices is written to a position at the end of the temperature tracking data structure.

28. The data processing apparatus of claim 27, wherein
the data storage additionally holds an allocation data structure, and
in response to a request to write data to be stored, the storage allocation routine performs steps of:
reading data from the data record at the beginning of the active temperature tracking data structure, determining if the pair of data storage devices with which the data record is associated is available, and selecting the pair of data storage devices in response to determining it is available;
in response to determining that the pair of data storage devices is not available reading data from successive data records following the data record at the beginning of the active temperature tracking data structure, determining if the pair of data storage devices with which the data record is associated is available, and selecting the pair of data storage devices in response to determining it is available, and
writing data to the allocation data structure identifying the selected pair of data storage devices to the storage allocation data structure and writing the data to be stored to the selected pair of data storage devices.

29. The data processing apparatus of claim 28, wherein, in response to a request to read stored data, the storage allocation routine performs steps of:
reading locations of the stored data from the storage allocation data structure;
reading data from successive data records within the active temperature tracking data structure to find the pair of data storage devices in which the stored data is stored, and to determine which of the data storage devices within the pair of data storage devices is cooler; and
reading the stored data from a cooler data storage device in the pair of data storage devices.

30. The data processing apparatus of claim 1, wherein
each of the data processing devices is a communication adapter circuit connected to a network,
the apparatus additionally includes a bus connecting the communication adapter circuits for transferring a data signal from one communication adapter circuit to another, and
the control device includes a microprocessor programmed to transfer a data signal from a first communications adapter circuit to a second communications adapter circuit in response to determining that the second communications adapter circuit has a cooler operating temperature than the first communications adapter circuit.

31. The data processing apparatus of claim 1, wherein
the apparatus additionally includes a communication network,
each of the data processing devices includes a computer system connected to the communication network,
the control device includes a server transmitting a data signal along the communication network to be received by a computer system having an operating temperature cooler than at least one other computer system attached to the communication network.

32. A method for allocating redundant data processing devices, wherein the method comprises:
generating a temperature tracking data structure including a data record indicating an operating temperature of each device within the redundant data processing devices; and
allocating a device within the redundant data processing devices for processing data, wherein the device allocated has an operating temperature indicated within the temperature tracking data structure to be lower than an operating temperature of at least one other data processing device within the redundant data processing devices.

33. The method of claim 32, wherein
the temperature tracking data structure includes a data record associated with each device within the redundant data processing devices,
data records within the temperature tracking data structure are arranged in order of measured operating temperatures of the devices with which the data records are associated, and
data records are read in order of their arrangement within the temperature tracking data structure, starting with a data record associated with a device within the redundant data processing devices for which a coolest operating temperature has been measured.

34. The method of claim 33, wherein
a temperature tracking routine causes a temperature tracking method to be periodically performed, and
the temperature tracking method includes, for each data processing device within the redundant data processing devices, measuring the device temperature and writing device data identifying the device and the device temperature to the temperature tracking data structure.

35. The method of claim 34, wherein
the temperature tracking routine causes data to be written to an inactive temperature tracking data structure within data storage,
a device allocation routine for allocating a device for processing data causes data to be read from an active temperature tracking data structure within the data storage,
when data for each data processing device within redundant data processing devices has been written to the inactive temperature tracking data structure, the inactive temperature tracking data structure becomes inactive, and the previously active data structure becomes inactive.

36. The method of claim 35, wherein, during performance of the temperature tracking method,
data for a first data processing device is written to a data record at a beginning of the temperature tracking data structure,
an operating temperature for each data processing device measured after the operating temperature of the first data processing device is compared with an operating temperature recorded in each data record in the temperature tracking routine in an order in which data records have been written until it is determined that the operating temperature for the data processing device is hotter than the operating temperature recorded in the data record,
in response to determining that the operating temperature of the data processing device measured after the operating temperature of the first data processing device is hotter than the operating temperature recorded in the data record, the data record and subsequent data records are shifted toward an end of the temperature tracking data structure, and data corresponding to the data processing device is written to the position of the data record, and
if it is determined that the operating temperature of a data processing device is hotter than each of the operating temperatures recorded in the data record, data corresponding to the data processing device is written to a position at the end of the temperature tracking data structure.

37. A method for storing and retrieving data within redundant data storage devices, wherein the method comprises:
writing data to be stored in two data storage devices within the redundant data storage devices;
determining which of two redundant data storage devices in which data to be retrieved is stored is cooler; and
reading the data to be retrieved from the cooler of the two redundant data storage devices.

38. The method of claim 37, wherein
the method additionally comprises generating a temperature tracking data structure including an operating temperature of each device within the redundant data storage devices, and
data within the temperature tracking data structure is used to determine which of the two redundant data storage devices in which data to be retrieved is stored is cooler.

39. The method of claim 38, wherein
the temperature tracking routine causes data to be written to an inactive temperature tracking data structure within data storage,
a storage allocation routine for determine which of the two redundant data storage devices in which data to be retrieved is stored is cooler causes data to be read from an active temperature tracking data structure within the data storage,
when data for each data stage device within redundant data storage devices has been written to the inactive temperature tracking data structure, the inactive temperature tracking data structure becomes inactive, and the previously active data structure becomes inactive.

40. The method of claim 38, wherein, during performance of the temperature tracking method,
data for a first data storage device is written to a data record at a beginning of the temperature tracking data structure,
an operating temperature for each data storage device measured after the operating temperature of the first data storage device is compared with an operating temperature recorded in each data record in the temperature tracking routine in an order in which data records have been written until it is determined that the operating temperature for the data storage device is hotter than the operating temperature recorded in the data record,
in response to determining that the operating temperature of the data storage device measured after the operating temperature of the first data storage device is hotter than the operating temperature recorded in the data record, the data record and subsequent data records are shifted toward an end of the temperature tracking data structure, and data corresponding to the data storage device is written to the position of the data record, and
if it is determined that the operating temperature of a data storage device is hotter than each of the operating temperatures recorded in the data record, data corresponding to the data storage device is written to a position at the end of the temperature tracking data structure.

41. The method of claim 40, wherein
the method additionally comprises determining which data storage devices within the redundant data storage devices are the two coolest data storage devices from data stored within the temperature tracking data structure, and
data is written to the two coolest data storage devices.

42. The method of claim 39, wherein
the temperature tracking data structure includes a data record associated with each of a number of pairs of data storage devices within the redundant data storage devices,
data records within the temperature tracking data structure are arranged in order of measured operating temperatures of the hotter data storage device within each of the pairs of data storage devices with which the data records are associated, and
data records are read by a storage allocation routine in order of their arrangement within the temperature tracking data structure, starting with a data record associated with a pair of data storage devices within the plurality of data storage devices for which a coolest operating temperature for the hotter data storage device within the pair has been measured.

43. The method of claim 42, wherein
the method additionally comprises determining which pair of data storage devices within the redundant data storage devices has a hotter data storage device with a cooler operating temperature than each other pair of data storage devices within the redundant data storage devices, and
data is written to the pair of data storage devices having a hotter data storage device with a cooler operating temperature than each other pair of data storage devices within the redundant data storage devices.

44. A computer readable medium having computer executable instructions for performing a method for allocating redundant data processing devices, wherein the method comprises:
generating a temperature tracking data structure including a data record indicating an operating temperature of each device within the redundant data processing devices; and
allocating a device within the redundant data processing devices for processing data, wherein the device allocated has an operating temperature indicated within the temperature tracking data structure to be lower than an operating temperature of at least one other data processing device within the redundant data processing devices.

45. The computer readable medium of claim 44, wherein
the temperature tracking data structure includes a data record associated with each device within the redundant data processing devices,
data records within the temperature tracking data structure are arranged in order of measured operating temperatures of the devices with which the data records are associated, and
data records are read in order of their arrangement within the temperature tracking data structure, starting with a data record associated with a device within the redundant data processing devices for which a coolest operating temperature has been measured.

46. The computer readable medium of claim 45, wherein
a temperature tracking routine causes a temperature tracking method to be periodically performed, and
the temperature tracking method includes, for each data processing device within the redundant data processing devices, measuring the device temperature and writing device data identifying the device and the device temperature to the temperature tracking data structure.

47. The computer readable medium of claim 46, wherein
the temperature tracking routine causes data to be written to an inactive temperature tracking data structure within data storage,
a device allocation routine for allocating a device for processing data causes data to be read from an active temperature tracking data structure within the data storage,
when data for each data processing device within redundant data processing devices has been written to the inactive temperature tracking data structure, the inactive temperature tracking data structure becomes inactive, and the previously active data structure becomes inactive.

48. The computer readable medium of claim 47, wherein, during performance of the temperature tracking method,
data for a first data processing device is written to a data record at a beginning of the temperature tracking data structure,
an operating temperature for each data processing device measured after the operating temperature of the first data processing device is compared with an operating temperature recorded in each data record in the temperature tracking routine in an order in which data records have been written until it is determined that the operating temperature for the data processing device is hotter than the operating temperature recorded in the data record,
in response to determining that the operating temperature of the data processing device measured after the operating temperature of the first data processing device is hotter than the operating temperature recorded in the data record, the data record and subsequent data records are shifted toward an end of the temperature tracking data structure, and data corresponding to the data processing device is written to the position of the data record, and
if it is determined that the operating temperature of a data processing device is hotter than each of the operating temperatures recorded in the data record, data corresponding to the data processing device is written to a position at the end of the temperature tracking data structure.

49. A computer readable medium having computer executable instructions for performing a method for storing and retrieving data within redundant data storage devices, wherein the method comprises:
writing data to be stored in two data storage devices within the redundant data storage devices;
determining which of two redundant data storage devices in which data to be retrieved is stored is cooler; and
reading the data to be retrieved from the cooler of the two redundangt data storage devices.

50. The computer readable medium of claim 49, wherein
the method additionally comprises generating a temperature tracking data structure including an operating temperature of each device within the redundant data storage devices, and
data within the temperature tracking data structure is used to determine which of the two redundant data storage devices in which data to be retrieved is stored is cooler.

51. The computer readable medium of claim 50, wherein
the temperature tracking routine causes data to be written to an inactive temperature tracking data structure within data storage,
a storage allocation routine for determine which of the two redundant data storage devices in which data to be retrieved is stored is cooler causes data to be read from an active temperature tracking data structure within the data storage,
when data for each data stage device within redundant data storage devices has been written to the inactive temperature tracking data structure, the inactive temperature tracking data structure becomes inactive, and the previously active data structure becomes inactive.

52. The computer readable medium of claim 50, wherein, during performance of the temperature tracking method,
data for a first data storage device is written to a data record at a beginning of the temperature tracking data structure,
an operating temperature for each data storage device measured after the operating temperature of the first data storage device is compared with an operating temperature recorded in each data record in the temperature tracking routine in an order in which data records have been written until it is determined that the operating temperature for the data storage device is hotter than the operating temperature recorded in the data record,
in response to determining that the operating temperature of the data storage device measured after the operating temperature of the first data storage device is hotter than the operating temperature recorded in the data record, the data record and subsequent data records are shifted toward an end of the temperature tracking data structure, and data corresponding to the data storage device is written to the position of the data record, and
if it is determined that the operating temperature of a data storage device is hotter than each of the operating temperatures recorded in the data record, data corresponding to the data storage device is written to a position at the end of the temperature tracking data structure.

53. The computer readable medium of claim 52, wherein
the method additionally comprises determining which data storage devices within the redundant data storage devices are the two coolest data storage devices from data stored within the temperature tracking data structure, and
data is written to the two coolest data storage devices.

54. The computer readable medium of claim 51, wherein
the temperature tracking data structure includes a data record associated with each of a number of pairs of data storage devices within the redundant data storage devices,
data records within the temperature tracking data structure are arranged in order of measured operating temperatures of the hotter data storage device within each of the pairs of data storage devices with which the data records are associated, and
data records are read by the storage allocation routine in order of their arrangement within the temperature tracking data structure, starting with a data record associated with a pair of data storage devices within the plurality of data storage devices for which a coolest operating temperature for the hotter data storage device within the pair has been measured.

55. The computer readable medium of claim 54, wherein
the method additionally comprises determining which pair of data storage devices within the redundant data storage devices has a hotter data storage device with a cooler operating temperature than each other pair of data storage devices within the redundant data storage devices, and
data is written to the pair of data storage devices having a hotter data storage device with a cooler operating temperature than each other pair of data storage devices within the redundant data storage devices.

56. A computer data signal embodied on a carrier wave having computer executable instructions for performing a method for allocating redundant data processing devices, wherein the method comprises:
generating a temperature tracking data structure including a data record indicating an operating temperature of each device within the redundant data processing devices; and
allocating a device within the redundant data processing devices for processing data, wherein the device allocated has an operating temperature indicated within the temperature tracking data structure to be lower than an operating temperature of at least one other data processing device within the redundant data processing devices.

57. The computer data signal of claim 56, wherein
the temperature tracking data structure includes a data record associated with each device within the redundant data processing devices,
data records within the temperature tracking data structure are arranged in order of measured operating temperatures of the devices with which the data records are associated, and
data records are read in order of their arrangement within the temperature tracking data structure, starting with a data record associated with a device within the redundant data processing devices for which a coolest operating temperature has been measured.

58. The computer data signal of claim 57, wherein
a temperature tracking routine causes a temperature tracking method to be periodically performed, and
the temperature tracking method includes, for each data processing device within the redundant data processing devices, measuring the device temperature and writing device data identifying the device and the device temperature to the temperature tracking data structure.

59. The computer data signal of claim 58, wherein
the temperature tracking routine causes data to be written to an inactive temperature tracking data structure within data storage,
a device allocation routine for allocating a device for processing data causes data to be read from an active temperature tracking data structure within the data storage,
when data for each data processing device within redundant data processing devices has been written to the inactive temperature tracking data structure, the inactive temperature tracking data structure becomes inactive, and the previously active data structure becomes inactive.

60. The computer data signal of claim 59 wherein, during performance of the temperature tracking method,
data for a first data processing device is written to a data record at a beginning of the temperature tracking data structure,
an operating temperature for each data processing device measured after the operating temperature of the first data processing device is compared with an operating temperature recorded in each data record in the temperature tracking routine in an order in which data records have been written until it is determined that the operating temperature for the data processing device is hotter than the operating temperature recorded in the data record,
in response to determining that the operating temperature of the data processing device measured after the operating temperature of the first data processing device is hotter than the operating temperature recorded in the data record, the data record and subsequent data records are shifted toward an end of the temperature tracking data structure, and data corresponding to the data processing device is written to the position of the data record, and
if it is determined that the operating temperature of a data processing device is hotter than each of the operating temperatures recorded in the data record, data corresponding to the data processing device is written to a position at the end of the temperature tracking data structure.

61. A computer data signal having computer executable instructions for performing a method for storing and retrieving data within redundant data storage devices, wherein the method comprises:
writing data to be stored in two data storage devices within the redundant data storage devices;
determining which of two redundant data storage devices in which data to be retrieved is stored is cooler; and
reading the data to be retrieved from the cooler of the two redundangt data storage devices.

62. The computer data signal of claim 61, wherein
the method additionally comprises generating a temperature tracking data structure including an operating temperature of each device within the redundant data storage devices, and
data within the temperature tracking data structure is used to determine which of the two redundant data storage devices in which data to be retrieved is stored is cooler.

63. The computer data signal of claim 62, wherein
the temperature tracking routine causes data to be written to an inactive temperature tracking data structure within data storage,
a storage allocation routine for determine which of the two redundant data storage devices in which data to be retrieved is stored is cooler causes data to be read from an active temperature tracking data structure within the data storage,
when data for each data stage device within redundant data storage devices has been written to the inactive temperature tracking data structure, the inactive temperature tracking data structure becomes inactive, and the previously active data structure becomes inactive.

64. The computer data signal of claim 62, wherein, during performance of the temperature tracking method,
data for a first data storage device is written to a data record at a beginning of the temperature tracking data structure,
an operating temperature for each data storage device measured after the operating temperature of the first data storage device is compared with an operating temperature recorded in each data record in the temperature tracking routine in an order in which data records have been written until it is determined that the operating temperature for the data storage device is hotter than the operating temperature recorded in the data record,
in response to determining that the operating temperature of the data storage device measured after the operating temperature of the first data storage device is hotter than the operating temperature recorded in the data record, the data record and subsequent data records are shifted toward an end of the temperature tracking data structure, and data corresponding to the data storage device is written to the position of the data record, and
if it is determined that the operating temperature of a data storage device is hotter than each of the operating temperatures recorded in the data record, data corresponding to the data storage device is written to a position at the end of the temperature tracking data structure.

65. The computer data signal of claim 64, wherein
the method additionally comprises determining which data storage devices within the redundant data storage devices are the two coolest data storage devices from data stored within the temperature tracking data structure, and
data is written to the two coolest data storage devices.

66. The computer data signal of claim 63, wherein
the temperature tracking data structure includes a data record associated with each of a number of pairs of data storage devices within the redundant data storage devices,
data records within the temperature tracking data structure are arranged in order of measured operating temperatures of the hotter data storage device within each of the pairs of data storage devices with which the data records are associated, and
data records are read by the storage allocation routine in order of their arrangement within the temperature tracking data structure, starting with a data record associated with a pair of data storage devices within the plurality of data storage devices for which a coolest operating temperature for the hotter data storage device within the pair has been measured.

67. The computer data signal of claim 66, wherein
the method additionally comprises determining which pair of data storage devices within the redundant data storage devices has a hotter data storage device with a cooler operating temperature than each other pair of data storage devices within the redundant data storage devices, and
data is written to the pair of data storage devices having a hotter data storage device with a cooler operating temperature than each other pair of data storage devices within the redundant data storage devices.
